(19) United States
(12) Patent Application Publication
(10) Pub. No.: US 2002/0002854 A1
(43) Pub. Date: Jan. 10, 2002

(54) Vehicle passenger distinguishment system with sensor cells installed inside seat

(76) Inventors: Yuzo Imoto, Chita-gun (JP); Tomoharu Yamanaka, Kuwana-gun (JP); Takehiro Sengoku, Kariya-city (JP); Kazuo Masaki, Chita-city (JP); Katsushi Mizushima, Yokkaichi-city (JP)

Correspondence Address: LAW OFFICE OF DAVID G POSZ, 2000 L STREET, N.W., SUITE 200, WASHINGTON, DC, 20036, US

(21) Appl. No.: 09/892,561

(22) Filed: Jun. 28, 2001

(30) Foreign Application Priority Data
Jul. 5, 2000 (JP) 2000-203464
Jul. 5, 2000 (JP) 2000-203866
Aug. 25, 2000 (JP) 2000-255233
Sep. 20, 2000 (JP) 2000-285550

(51) Int. Cl. G01G 19/56; G01L 25/00

(52) U.S. Cl. 73/1.13; 73/862.541; 73/862.55

(57) ABSTRACT

When a passenger distinguishment system is produced, after a seat cover is attached to a seat cushion while applying a tension to the seat cover, a conditioning operation is performed to lessen an adverse effect of the tension with respect to sensitivities of plural sensor cells that are disposed between the sensor cushion and the seat cover. The conditioning operation can disperse the tension of the seat cover, so that the sensor cells can detect loads applied to the seat accurately.

### CROSS REFERENCE TO RELATED APPLICATIONS

This application is based upon and claims the benefit of Japanese Patent Applications No. 2000-203464 filed on Jul. 5, 2000, No. 2000-203866 filed on Jul. 5, 2000, No. 2000-255233 filed on Aug. 25, 2000, and No. 2000-285550 filed on Sep. 20, 2000, the contents of which are incorporated herein by reference.

### BACKGROUND OF THE INVENTION

1. Field of the Invention

This invention relates to a vehicle passenger distinguishment system having a sensor installed in a vehicle passenger seat for sensing presence of a passenger on the seat and for performing distinguishment of the passenger, based on an output from the sensor.

2. Description of the Related Art

Conventionally, a passenger is obligated to wear a seat belt as a safety measure so that the passenger can be protected from shock of a vehicle collision. When the seat belt is not fastened, the passenger may be warned by a buzzer or a warning light to fasten the seat belt. On the other hand, recently, the number of vehicles equipped with air bags has been increased rapidly. In a vehicle equipped with an air bag for a seat next to a driver's seat (i.e., for a passenger seat), a technique for preventing the air bag from inflating when no passenger sits on the seat has been developed and brought into practical use.

When the passenger is to be warned to fasten the seat belt or when the air bag for the passenger seat is to be prevented from inflating, it is necessary to sense whether a passenger is sitting on the seat or not. In this connection, a passenger sensing system having a pressure-sensitive sensor installed in the seat is known as a method for sensing the presence of the passenger.

Further, because the air bag provided as a safety device inflates with a large inflating force, in a case where a child sits on the passenger seat, the air bag should be controlled to inflate with a reduced inflating force or not to be operated. As a method for determining whether the passenger is a child or not, it is conceivable to utilize the above-described passenger sensing system. Specifically, whether the passenger is a child or not can be decided based on a load detected by the pressure-sensitive sensor installed in the seat. For example, when the load is smaller than a predetermined magnitude, the passenger is considered as a child. However, this method has the following problems.

Firstly, even when the passenger is an adult, the load detected by the pressure-sensitive sensor would be reduced apparently if the passenger reclined the seat back. Secondly, in case where a child seat (a seat for child's exclusive use such as baby seat, child seat, or junior seat) is placed on the passenger seat, the load is increased because it corresponds to the sum of the weight of a child sitting on the seat and the weight of the child seat. Thirdly, when the child seat is used, the load detected by the pressure-sensitive sensor varies due to a fastening force of a seat belt for fixing the child seat on the passenger seat. Thus, it is very difficult to decide correctly whether the passenger is a child or not by the conventional passenger sensing system.

### SUMMARY OF THE INVENTION

In this connection, a passenger distinguishment system has been devised and developed to distinguish a child from an adult regardless of presence of a child seat. The passenger distinguishment system has plural sensor cells arranged on a sheet (mat) that is installed in a sensor cushion (under the seat surface). A passenger is distinguished based on a sum of loads detected by outputs from the individual sensor cells, and the load distribution obtained by the loads.

For example, the load distribution obtained by the outputs from the sensor cells largely differs between a case where a passenger is sitting on the seat directly and a case where a child seat is placed on the seat. Therefore, the presence of the child seat is determined based on the load distribution. Also, even when the child seat is not used, whether a passenger is a child or not is determined considering not only the sum of loads detected by the sensor cells but also the load distribution. Accordingly, a child can be distinguished from an adult more correctly.

When this passenger distinguishment system is produced, after assembling, calibration of sensor sensitivity, product check and the like are performed. At that time, if a seat cover covering the surface of the seat has biased tension, positional slippage, and the like, the individual sensor cells cannot receive inputs corresponding to actually applied pressure. That is, although the seat cover is attached while receiving a tension so as to prevent slack (wrinkle) from appearing externally, the tension is liable to be biased on the attached seat cover, and the bias can cause slippage of the seat cover and the like. When the calibration of the sensor sensitivity and the product check are performed in this state, the sensor cells cannot detect loads corresponding to actually applied pressure.

The present invention has been made in view of the above problems. An object of the present invention is to provide a passenger distinguishment system having plural sensor cells installed in a seat and capable of detecting loads applied to the seat accurately.

According to one aspect of the present invention, a passenger distinguishment system is produced by attaching a seat cover to a seat cushion while applying a tension to the seat cover and by performing a conditioning operation to lessen an effect of the tension with respect to sensitivities of a plurality of sensor cells that is provided with the seat cushion. Preferably, the conditioning operation involves applying an external force to the seat cover and releasing the seat cover from the external force. The conditioning operation can disperse the tension of the seat cover uniformly.

According to another aspect of the present invention, after a seat cover is attached to a seat cushion, a sensor output judgment step is performed to decide whether outputs from a plurality of sensor cells are stable or not. Preferably, whether the outputs from the sensor cells are stable or not is decided based on an output value from a judgment cell that is disposed on a sensor mat together with the sensor cells. The judgment cell may be a dummy sensor or one selected from the sensor cells. If it is decided that the outputs from the sensor cells are not stable, a conditioning operation can be performed to make the outputs stable.

### BRIEF DESCRIPTION OF THE DRAWINGS

Other objects and features of the present invention will become more readily apparent from a better understanding of the preferred embodiments described below with reference to the following drawings, in which;

FIG. 1 is a perspective view showing a seat;

FIG. 2 is an exploded perspective view showing the seat;

FIG. 3A is a plan view showing a cushion of the seat with a sensor mat in a first preferred embodiment of the present invention;

FIG. 3B is a side view showing the cushion with the sensor mat;

FIG. 4 is a cross-sectional view showing a first step for attaching a seat cover to the cushion;

FIG. 5 is a cross-sectional view showing a second step for attaching the seat cover to the cushion;

FIG. 6 is a flowchart showing a manufacturing method of the seat;

FIGS. 7A to 7C are cross-sectional views each showing a seat at each example of a conditioning step, which correspond to a cross-section taken along line VII-VII in FIG. 1;

FIGS. 8A and 8B are schematic views showing examples of the conditioning step in which a pressurized region of the seat is divided into several groups;

FIGS. 9A and 9B are schematic views for explaining an example of the conditioning step in which the seat is pressurized by a roller;

FIGS. 10A and 10B are schematic views for explaining an example of the conditioning step in which air is blown toward or sucked from an inner side of the seat cover;

FIG. 11 is a schematic view for explaining an example of the conditioning step in which the seat is heated and pressurized by air;

FIGS. 12A to 12C are plan views showing pressurized regions on the seat by air;

FIG. 13A is a plan view showing a cushion holding a sensor mat in a second preferred embodiment of the present invention;

FIG. 13B is a side view showing the cushion holding the sensor mat;

FIGS. 14A and 14B are cross-sectional views showing a seat for explaining deformation of the cushion by stress; and

FIG. 15 is a graph showing a change in output value of a judgment cell after the seat cover is attached to the cushion and after stress produced to the cushion is removed.

### DETAILED DESCRIPTION OF THE PREFERRED EMBODIMENTS

(First Embodiment)

First, a structure and a manufacturing method of a seat 1 used for a passenger distinguishment system according to the present invention are explained.

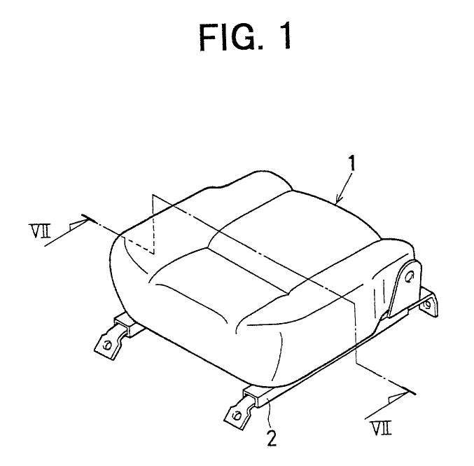

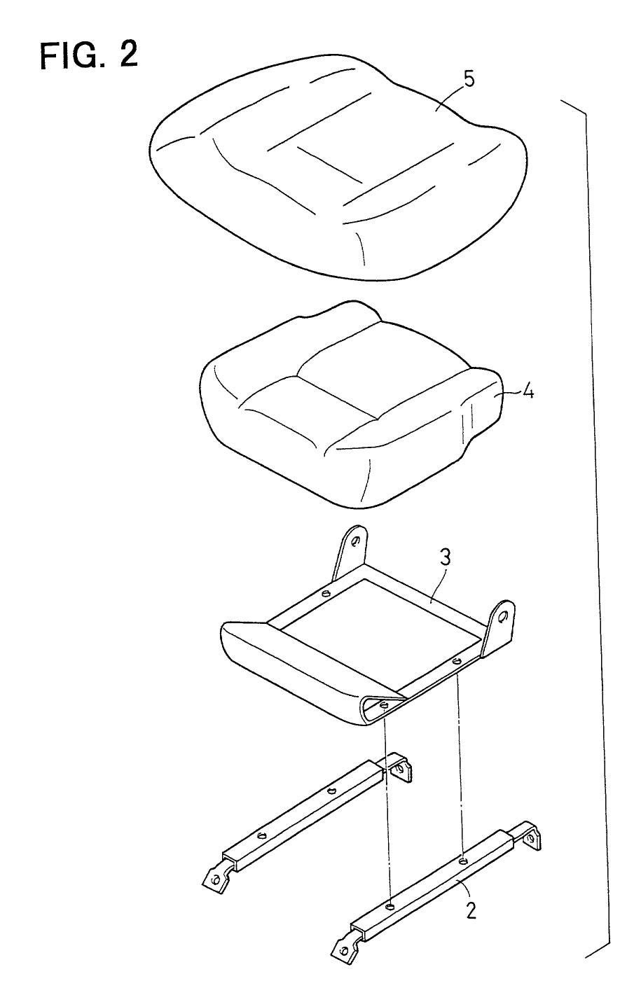

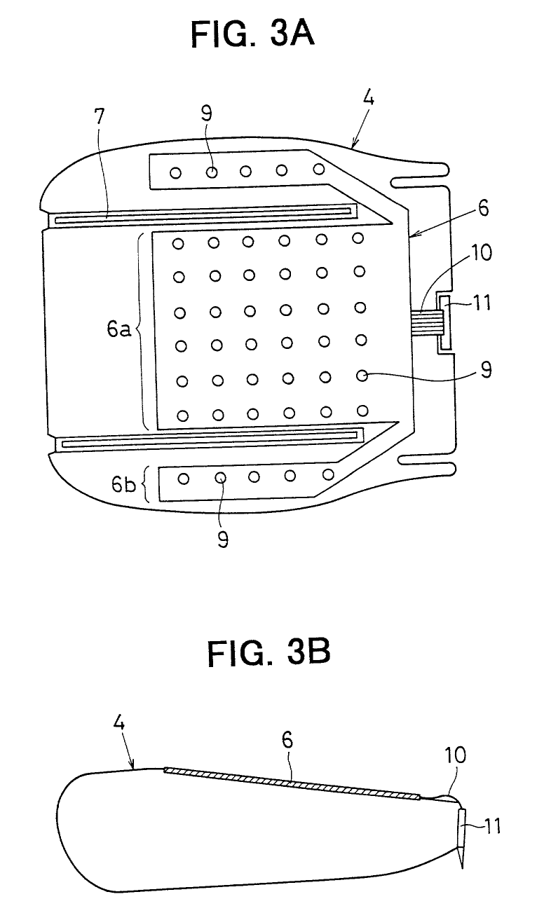

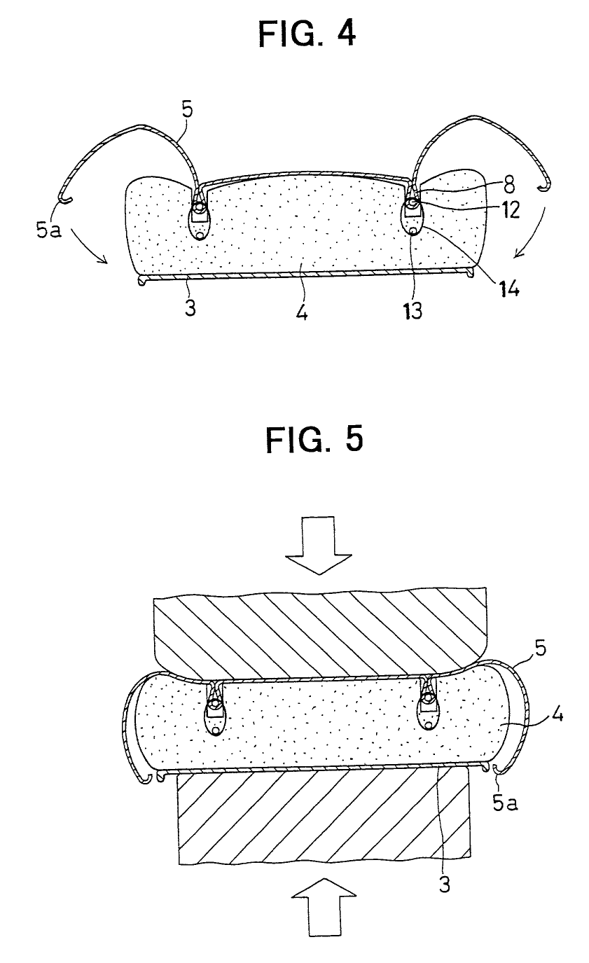

Referring to FIGS. 1 and 2, the seat 1 is composed of slide rails 2, an anchor 3 supported by the slide rails 2, a seat cushion 4 disposed on the anchor 3, and a seat cover (skin) 5 covering the surface of the cushion 4. As shown in FIGS. 3A and 3B, a sensor mat 6 is disposed between the cushion 4 and the seat cover 5. The cushion 4 constitutes a basal portion (base) of the seat 1, and trenches 7 are formed on the upper surface of the cushion 4, in which parts of the seat cover 5 is to be crammed (inserted). The seat cover 5 is crammed inside the cushion 4 along the trenches 7, so that the crammed portions (trench portions) appear on the seat 1 as design. Referring to FIG. 4, the back surface of the seat cover 5 has bag-shaped folds 8 that protrude to be crammed into the trenches 7.

Hereinafter, of the cushion 4, the portion surrounded (sandwiched) by the trenches 7 is referred to as a middle portion, and the portions provided at outer sides of the respective trenches 7 are referred to as side portions. Of the seat cover 5, the portion surrounded (sandwiched) by the folds 8 is referred to as a middle portion, and the portions provided at outer sides of the respective folds 8 are referred to as side trims.

Referring again to FIG. 3A, the sensor mat 6 is composed of a first sensor portion 6a disposed on the middle portion of the seat 1, and second sensor portions 6b disposed on the side portions of the seat 1 (at outer sides of the respective trenches 7), and integrated with the first sensor portion 6a. Plural sensor cells 9 are arranged on the first sensor portion 6a at a constant interval both in the front-rear direction and in the lateral direction, and sensor cells 9 are also arranged on the second sensor portions 6b at a constant interval in the longitudinal direction of the second sensor portions 6b. Each of the sensor cells 9 is, for example, a pressure transducer element having a resistance that changes in response to a pressure, and the sensor cells 9 disposed on the sensor mat 6 detect pressures independently of one another.

The sensor mat 6, which is connected to an ECU 11 via a printed circuit board 10, converts changes in pressure detected by the respective sensor cells 9 into electric signals, and transmits the signals to the ECU 11. The ECU 11 is an electric control unit holding a microcomputer therein, and, as shown in FIGS. 3A and 3B, is attached to approximately a center of a rear edge side of the cushion 4. The ECU 11 detects a total load applied to the upper surface of the cushion 4 and the load distribution, based on the output signals from the respective sensor cells 9. The ECU 11 then decides presence of a passenger and presence of a child seat (seat for child's exclusive use), and further performs distinguishment of a child from an adult in the following manners.

[Presence of Passenger]

The sum of the loads detected by the respective sensor cells 9 is calculated. Then, it is decided that a passenger sits on the seat 1 if the sum is equal to or larger than a predetermined value, and it is decided that no passenger sits on the seat 1 if the sum is smaller that the predetermined value.

[Presence of Child Seat]

The load distribution on the seat 1 is detected based on the output signals from the respective sensor cells 9. Then, it is decided whether a child seat is used or not based on a shape pattern that can be presumed from the load distribution.

[Distinguishment of Child from Adult]

Whether the passenger is a child or not is finally decided by considering both the sum of the loads and the load distribution.

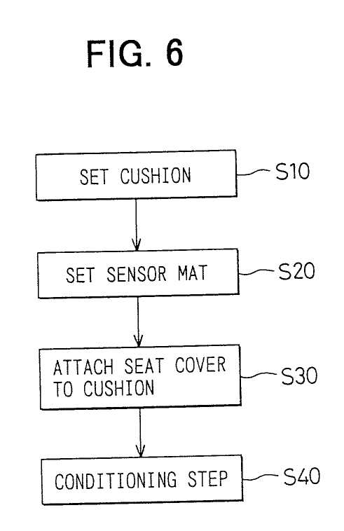

Next, the manufacturing method of the seat 1 is explained referring to FIG. 6 showing a flowchart of manufacturing steps. First, in step S10, the cushion 4 is set on the anchor 3. In step S20, as shown in FIGS. 3A and 3B, the sensor mat 6 is disposed at a specific position on the upper surface of the cushion 4. In this step, the sensor mat 6 is temporarily fixed to the cushion 4, so that it can be prevented from being shifted from the specific position when the seat cover 5 is attached in the following step.

Then, in step S30, the seat cover 5 is spread out and attached to the cushion 4 in the following procedure. Specifically, in a first step, as shown in FIG. 4, the middle portion of the seat cover 5 is placed to fit the middle portion of the cushion 4. Wires 12 are disposed to pass through the respective folds 8, while wires 13 are disposed inside the cushion 4. Then, each of C-shaped hog rings (C-shaped clamps) 14 catches each pair of the wires 12 and 13 together, and then is fastened and closed. Accordingly, the middle portion of the seat cover 5 is fitly attached to the middle portion of the cushion 4.

In a second step, the side trims of the seat cover 5 are extended to cover not only the side portions but also those outer sides of the cushion 4, and hooks 5a provided at the edges of the respective side trims are hooked on the peripheral portion such as the anchor 3. This step is performed so that tensions are applied to the side trims in an assembled state so as to prevent wrinkles and slacks of the seat cover 5.

That is, as shown in FIG. 5, the side trims of the seat cover 5 are attached to the cushion 4 while pressing the cushion 4 in upper and lower directions, and the pressures applied to the cushion 4 in the upper and lower directions are released after the hooks 5a of the side trims are hooked on the peripheral portion such as the anchor 3. Accordingly, the side trims are fitly attached to the cushion 4 to cover the side portions and the outer sides of the cushion 4 while receiving tensions (i.e., without any slacks). FIG. 1 shows an entirety of the seat 1 to which the seat cover 5 is attached as described above.

Then, in step S40, a conditioning operation is performed (conditioning step). This conditioning step is performed to ease adverse effects to the sensitivities of the sensor cells 9, caused by the initial tension applied to the seat cover 5 for attachment. Specifically, it is performed to eliminate bias of the initial tension applied to the seat cover 5, the slippage of the seat cover 5 produced by the bias, partial separation of the seat cover from the sensor cells 9 (as it is floating), and the like. The conditioning step involves applying an external force to the seat 1 from the surface of the seat cover 5, and releasing the seat 1 from the external force. The number of times of this conditioning operation, i.e., the number of times of the application and release of and from the external force, is set arbitrary in accordance with kind, shape, and the like of the product (seat 1), and can be changed appropriately.

Preferable examples (manners) of the conditioning operation are explained below.

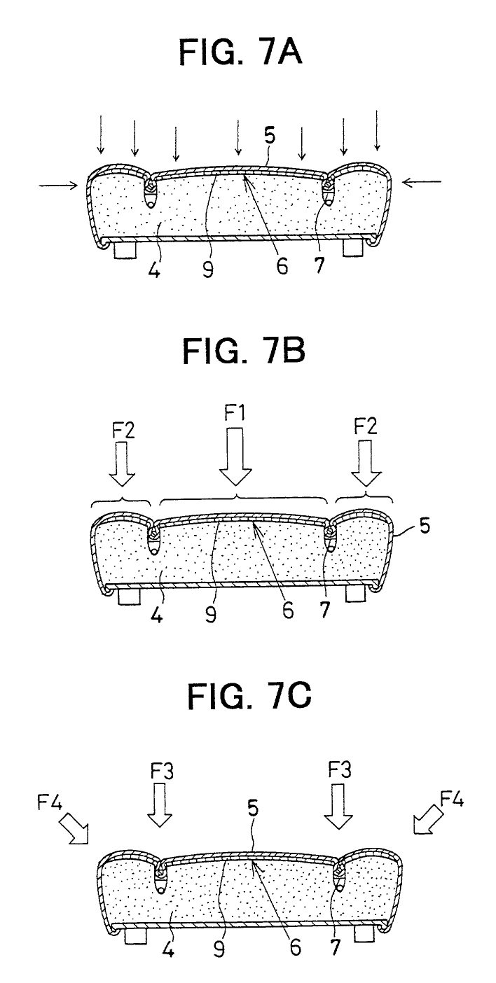

(a) The external force is applied to an entire area of the seat cover 5 uniformly (without bias) as shown in FIG. 7A.

(b) The external force is applied to the middle portion of the seat cover 5 intensively as indicated by arrow Fl FIG. 7B.

(c) The external force is applied to the side trims of the seat cover 5 intensively as indicated by arrows F2 in FIG. 7B.

(d) The external force is applied to the trench portions of the seat cover 5 intensively as indicated by arrows F3 in FIG. 7C. Here, as described above, the trench portions correspond to the boundaries between the middle portion and the respective side trims of the seat cover 5, where the folds 8 of the seat cover 5 are crammed into the trenches 7 of the cushion 4.

(e) The external force is applied to the outer edge portion (corner portion) of the seat cover 5 intensively as indicated by arrow F4 in FIG. 7C.

(f) The seat cover 5 or the entirety of the seat 1 is swung (vibrated) to make the seat cover 5 stable (to rearrange the seat cover 5 to its desirable position without slippage) with respect to the cushion 4.

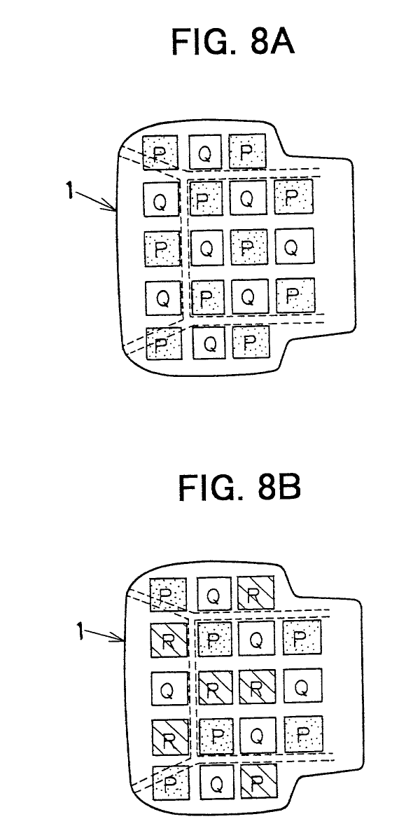

(g) The regions (pressurized region) of the seat 1 to which external force is to be applied is divided into several groups, and the force is applied at several steps for the respective groups. For example, as shown in FIG. 8A, the pressurized region is divided into group P and group Q and the application of the force is performed at two steps for the respective groups P, Q. Otherwise, as shown in FIG. 8B, the pressurized region is divided into three groups P, Q, and R, and the application of the force is performed at three steps for the respective groups P, Q, and R. In this case, it is preferable that the pressurized regions of the respective groups are dispersed at the entire area of the seat surface. Accordingly, the entire area of the seat can be pressurized uniformly with a desirable pattern, so that the time required for the conditioning operation can be shortened.

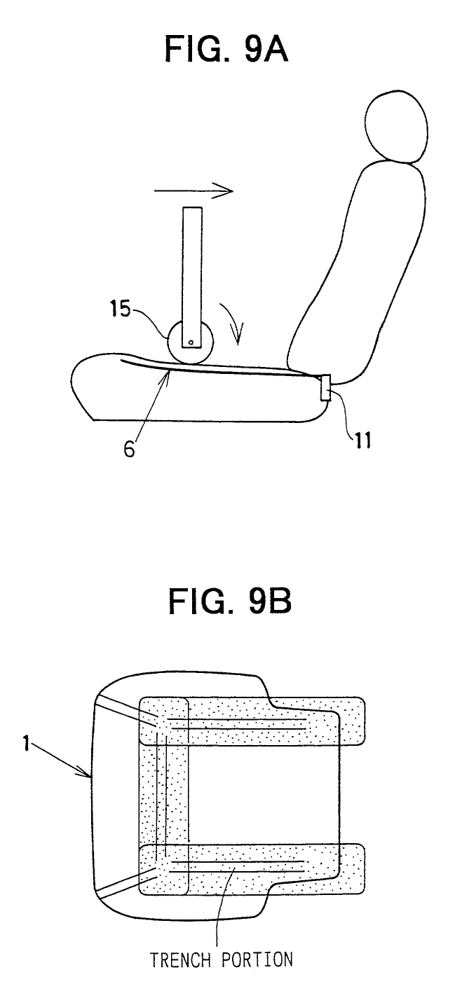

(h) As shown in FIG. 9A, it is performed using a roller 15. Any one of the above examples (a) to (e) can adopt this roller 15 to perform the conditioning step effectively. One example is shown in FIG. 9B, in which the roller 15 pressurizes the trench portions of the seat 1 (corresponding to the hatched regions in the figure).

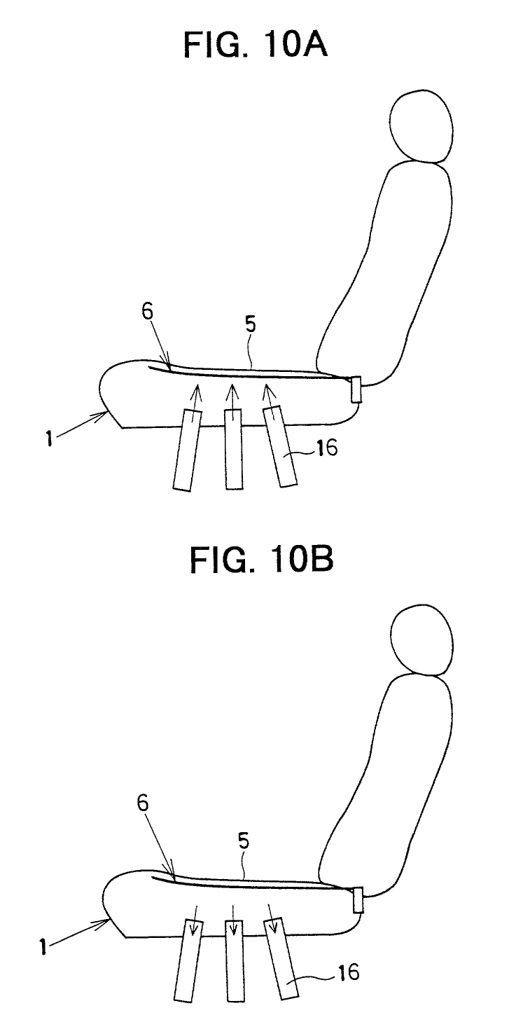

(i) In every example (a)-(h) described above, the external force is applied to the seat surface; however, in this example, air is blown toward the seat cover 5 from the inner side thereof to perform pressurization, otherwise, air is sucked from the inner side of the seat cover 5 to perform depressurization. For example, as shown in FIG. 10A, air nozzles 16 may be used to blow out air toward the inner side of the seat cover 5. Further, as shown in FIG. 10B, air nozzles 16 may be used to suck air from the inner side of the seat cover 5.

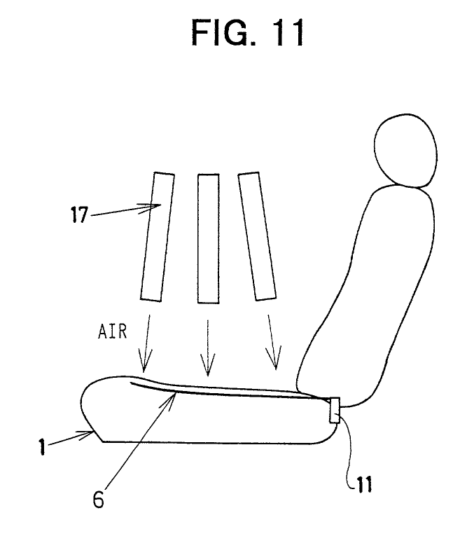

(j) Heat may be imparted to the seat 1. That is, in this example, heat is imparted to the seat 1 instead of applying external force to the seat 1 with an object contacting the seat 1. For example, there are several methods for heating the seat 1, such as an enforced method that heated air is blown out toward the seat 1 from nozzles 17 as shown in FIG. 11, a room-temperature adaptation method that the seat 1 is placed in a heating chamber having a controlled temperature so that the seat 1 is adopted to have the controlled temperature, and a steam heating method that steam is blown out to the seat 1. In these methods, because it is not necessary to use a member for directly contacting the product (seat 1), these methods can be performed flexibly even when the product shape is complicated. The seat 1 may be heated not from the upper surface thereof but from the side surfaces or the bottom surface thereof appropriately by the above methods.

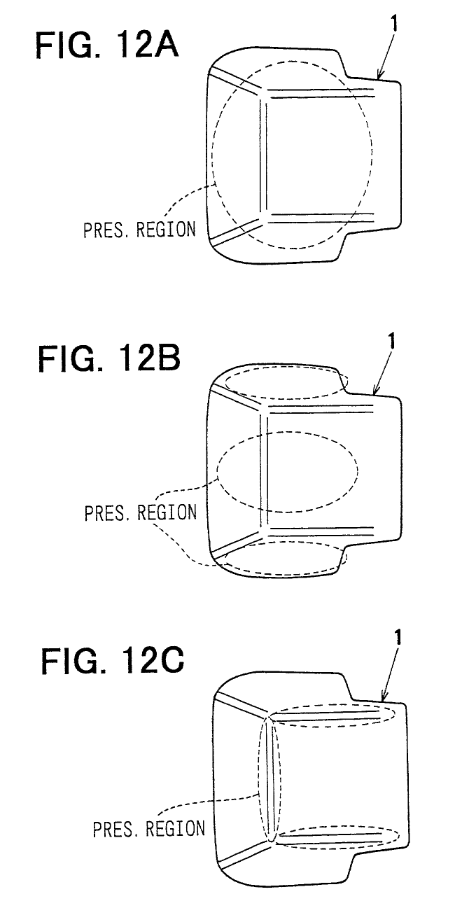

The enforced method shown in FIG. 11 can be combined with any one of the above examples (a) to (e). That is, by using pressurized air as external force, the pressurized region on the seat 1 can be controlled easily because the nozzles need not contact the seat cover 5 directly. For example, as shown in FIG. 12A, the entire area of the seat 1 may be pressurized by pressurized air. As shown in FIG. 12B, the middle portion and the side portions of the seat 1 may be pressurized by pressurized air separately and intensively. As shown in FIG. 12C, the trench portions of the seat 1 may be pressurized by pressurized air intensively. Air to be blown to the seat 1 may not be pressurized by the nozzles 17, but may be pressurized by other means. Further, air to be blown to the seat 1 may not be heated provided that it is pressurized.

According to the present embodiment, in the manufacturing method of the seat 1 having the sensor, after the seat cover 5 is fitly attached to the cushion 4, the conditioning operation is performed as described above. This operation can eliminate the bias of tension applied to the seat cover 5, the slippage of the cover 5 caused by the bias, the separation (floating) of the cover 5 from the sensor cells 9, and the like. In other word, the conditioning operation can disperse the initial tension applied to the seat cover 5 uniformly. As a result, the initial tension applied to the seat cover 5 can be restricted from being adversely affected to the sensitivities of the individual sensor cells 9. The sensor cells 9 can detect actual pressures accurately, thereby enabling stable check and desirable initial performance of the sensor.

The contact surfaces of the cushion 4 and the seat cover 5 are preferably made of material (for example, Teflon base or nylon base) that makes the contact surfaces easily slide on each other to reduce the adverse effects to the sensor output caused by the attachment state of the seat cover 5 involving the bias of the tension and slippage. In this case, because the cushion 4 and the seat cover 5 easily slide on each other, the conditioning operation described above can effectively eliminate the bias of the tension, the slippage of the seat cover 5, and the like.

In the present embodiment, although the application and release of and from the external force to and from the seat 1 are performed in the conditioning step as described above. However, they may be performed in a calibration step or in a product check. Here, calibration is an operation for applying a pressure to the respective sensor cells 9 uniformly from the seat surface of the seat cover5 to adjust sensitivity of each sensor cell 9. If there existed variation insensitivity among the sensor cells 9 disposed on the sensor mat 9, the load distribution determined by the outputs from the sensor cells 9 would vary, and not always coincide with an actual load distribution. The calibration step is performed to prevent this variation. Further, the product check is a check that is performed after the conditioning step and the calibration step are performed, by applying a mimetic load to the seat 1, assuming a practical usage state.

Each method and each pressurized region of the seat 1 in the conditioning step, the calibration step, and the product check should be selected appropriately and may be the same as or different from each other. When all of the conditioning step, the calibration step, and the product check involve pressurization of the seat 1, as shown in FIG. 11, the method using pressurized air is preferably adopted for all the steps. According to this method, the pressurized region of the seat 1 can be changed easily depending on the step because it is not necessary to contact the surface of the seat cover 5 directly. Especially, the method shown in FIG. 11 is preferable for the product check because it can easily reproduce the load distribution when a passenger sits on the seat 1, in comparison with a method utilizing a pad or the like for applying pressure to the seat 1. In the embodiment described above, although the seat 1 is pressurized mainly from the seat surface thereof, it may be pressurized from the side surfaces or from the back surface similarly.

(Second Embodiment)

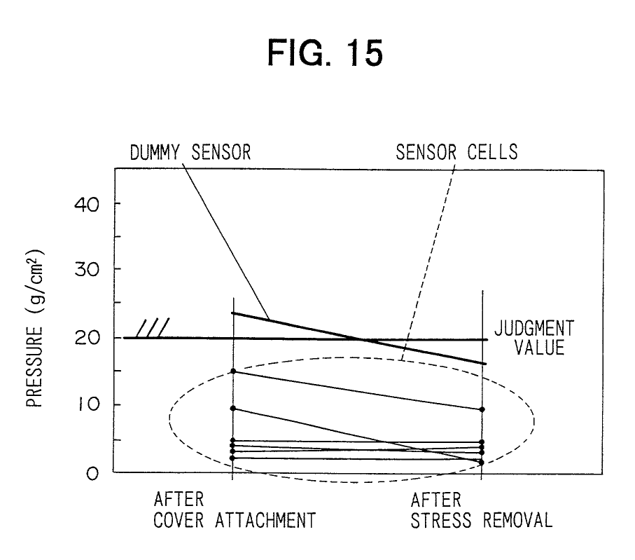

In a second preferred embodiment, after the seat cover 5 is attached to the cushion 4 at step S30 shown in FIG. 6, a sensor output judgment step is performed to judge whether the sensor outputs from the individual sensor cells 9 disposed on the sensor mat 6 are stable or not, by predetermining one of the sensor cells 9 as a judgment cell 9a and by comparing the output from the judgment cell 9a with a judgment (reference) value (FIG. 15).

The sensor cell, which is selected as the judgment cell 9a, should be arranged at a portion (for example, in the vicinity of a corner of the cushion 4 or in the vicinity of the trench portions) where large stress is liable to be produced to the cushion 4 by the attachment of the seat cover 5 in a state where the sensor mat 6 is installed in the seat 1.

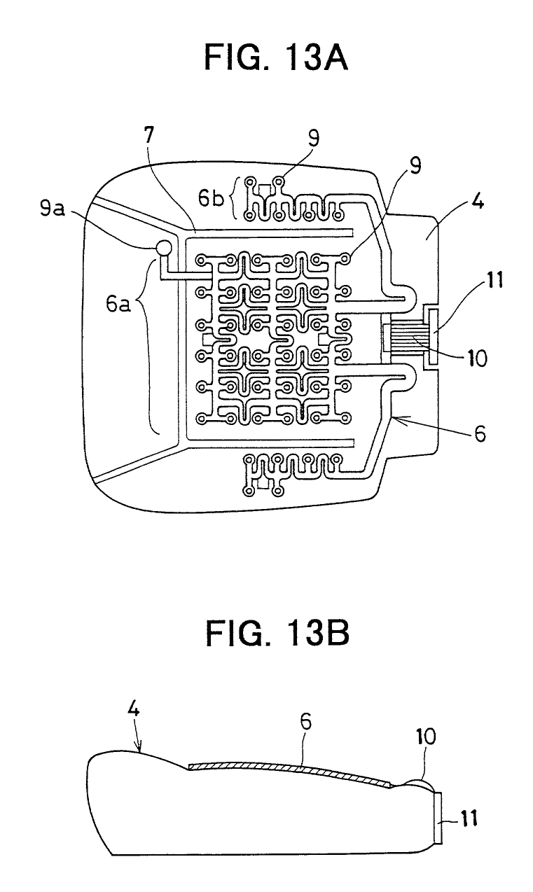

In a case where the sensor mat 6 has no sensor cell 9 at the portion where large stress is liable to be produced to the cushion 4, as shown in FIG. 13A, a dummy sensor other than the sensor cells 9 used for distinguishment of a passenger, may be provided at that portion as a judgment cell 9a so that it is used only in the sensor output judgment step. The dummy sensor can detect a load having the same level (magnitude) of that the other sensor cells 9 can detect. FIGS. 13A and 13B are plan view and side view showing the cushion 4 holding the sensor mat 6, which correspond to FIGS. 3A and 3B, and in which the same or similar parts as those in FIGS. 3A and 3B are designated with the same reference numerals.

Next, a judgment method is explained below.

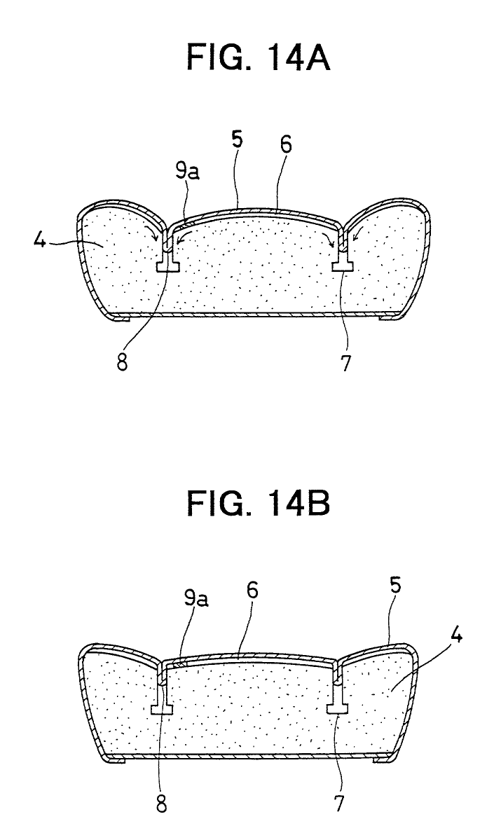

First, the output value of the judgment cell 9a is compared with the judgment value. Then, it is decided that the outputs from the individual sensor cells 9 are not stable when the output value of the judgment cell 9a is larger than the judgment value. In this case, as shown in FIG. 14A, stress is produced on the cushion 4 that receives the tensile applied to the seat cover 5, and the cushion 4 is largely deformed at the portions where stress is large, for example, in the vicinity of the trench portions as indicated by arrows in the figure. Because of this, the output value of the judgment cell 9a indicates a magnitude larger than the judgment value as shown in FIG. 15.

Therefore, when the output value of the judgment cell 9a is larger than the judgment value, the conditioning operation is performed to remove stress from the cushion 4, and after that, the sensor output judgment step is performed again. The conditioning operation can adopt various manners as described in the first embodiment. If the stress can be removed from the cushion 4 by the conditioning operation, as shown in FIG. 14B, the deformation of the cushion 4 is reduced, so that the output value of the judgment cell 9a is decreased as shown in FIG. 15.

On the other hand, when the output value of the judgment cell 9a is smaller than the judgment value, it is decided that the outputs of the individual sensor cells 9 are stable.

According to the second embodiment as described above, whether the outputs of the individual sensor cells 9 are stable or not can be judged by performing the sensor output judgment step after the seat cover 5 is attached to the cushion 4. Thus, the sensor output outputted from the sensor installed in the seat 1 becomes stable in a practical use, so that distinguishment of a passenger can be performed without misjudgment.

In the sensor output judgment step, the output value of the judgment cell 9a that is disposed in the vicinity of the portion where large stress is liable to be produced is compared with the judgment value. Because the judgment cell 9a is largely influenced by stress produced in the cushion 4 in comparison with the other sensor cells 9, whether the outputs of the sensor cells 9 are stable or not can be effectively and securely decided as compared to the case where one of the sensor cells 9 is used as an judgment cell 9a.

While the present invention has been shown and described with reference to the foregoing preferred embodiments, it will be apparent to those skilled in the art that changes in form and detail may be made therein without departing from the scope of the invention as defined in the appended claims.

What is claimed is:

1. A passenger distinguishment system for distinguishing a passenger on a seat based on outputs from a plurality of sensor cells installed in the seat, the passenger distinguishment system being prepared by a process comprising the steps of:
attaching a seat cover to a seat cushion of the seat while applying a tension to the seat cover, the seat cushion holding a sensor mat having the plurality of sensor cells for detecting a pressure applied to the seat; and
performing a conditioning operation to lessen an effect of the tension with respect to sensitivities of the plurality of sensor cells.

2. The passenger distinguishment system according to claim 1, wherein the conditioning operation comprises applying an external force to the seat cover, and releasing the seat cover from the external force.

3. The passenger distinguishment system according to claim 2, wherein the conditioning operation is performed to an entire area of the seat cover.

4. The passenger distinguishment system according to claim 2, wherein:
the seat has a middle portion and side portions sandwiching the middle portions, on a seat surface thereof, the middle portion being separated from the side portions by trench portions; and
the conditioning operation is performed to the trench portions.

5. The passenger distinguishment system according to claim 2, wherein the conditioning operation is performed to a middle portion of a seat surface of the seat.

6. The passenger distinguishment system according to claim 2, wherein the conditioning operation is performed to side portions of a seat surface of the seat.

7. The passenger distinguishment system according to claim 2, wherein the conditioning operation is performed to an outer edge portion of the seat.

8. The passenger distinguishment system according to claim 2, wherein the conditioning operation is performed by swinging the seat.

9. The passenger distinguishment system according to claim 2, wherein the external force is applied to the seat by a roller.

10. The passenger distinguishment system according to claim 2, wherein:
a surface region of the seat for receiving the external force is divided into first and second groups of pressurized regions; and
the external force is applied to the surface region at first and second steps for the respective first and second groups of pressurized regions.

11. The passenger distinguishment system according to claim l, wherein the conditioning operation comprises pressurizing the seat cover by air blown to an inner surface of the seat cover at a side of the seat cushion.

12. The passenger distinguishment system according to claim 1, wherein the conditioning operation comprises sucking air from an inner surface of the seat cover at a side of the seat cushion.

13. The passenger distinguishment system according to claim 1, wherein the conditioning operation comprises heating the seat.

14. The passenger distinguishment system according to claim 1, wherein:
an inner surface of the seat cover and an outer surface of the seat cushion contact each other with the sensor mat interposed therebetween; and
the inner surface of the seat cover and the outer surface of the seat cushion are made of a material that allows the inner surface and the outer surface to slide on each other.

15. A passenger distinguishment system for distinguishing a passenger on a seat based on outputs from a plurality of sensor cells installed in the seat, the passenger distinguishment system being prepared by a process comprising the steps of:
attaching a seat cover to a seat cushion of the seat while applying a tension to the seat cover, the seat cushion holding a sensor mat having the plurality of sensor cells that can detect a pressure applied to the seat independently of each other;
applying an external force to the seat from a seat surface of the seat cover, by blowing pressurized air onto the seat surface; and
releasing the seat from the external force.

16. The passenger distinguishment system according to claim, 15, wherein the pressurized air is blown to an entire area of the seat surface uniformly.

17. The passenger distinguishment system according to claim 15, wherein the pressurized air is blow to a middle portion and a side portion of the seat surface separately.

18. The passenger distinguishment system according to claim 15, wherein:
the seat has a trench portion where a part of the seat cover is crammed into a trench of the seat cushion; and
the air is blown to the trench portion.

19. A passenger distinguishment system for distinguishing a passenger on a seat based on outputs from a plurality of sensor cells installed in the seat, the passenger distinguishment system being prepared by a process comprising the steps of:
attaching a seat cover to a seat cushion of the seat while applying a tension to the seat cover, the seat cushion holding a sensor mat having the plurality of sensor cells that can detect a pressure applied to the seat independently of each other; and
performing a sensor output judgment step for deciding whether the outputs from the plurality of sensor cells are stable.

20. The passenger distinguishment system according to claim 19, wherein whether the outputs from the plurality of sensor cells are stable is decided based on an output value from a judgment cell that is disposed on the sensor mat.

21. The passenger distinguishment system according to claim 20, wherein:
in the sensor output judgment step, it is decided that the outputs from the plurality of sensor cells are not stable when the output value from the judgment cell is equal to or larger than a predetermined value;
a conditioning operation is performed to remove stress from the seat cushion that is produced by attaching the seat cover to the seat cushion; and
the sensor output judgment step is performed again after the conditioning operation is performed.

22. The passenger distinguishment system according to claim 20, wherein the judgment cell is disposed at a region of the sensor mat where large stress is produced to the seat cushion by attaching the seat cover to the seat cushion.

23. The passenger distinguishment system according to claim 20, wherein the judgment cell is a dummy cell separate from the plurality of sensor cells.

24. The passenger distinguishment system according to claim 20, wherein the judgment cell is one selected from the plurality of sensor cells.

25. A method for producing a passenger distinguishment system for distinguishing a passenger on a seat based on outputs from a plurality of sensor cells installed in the seat, the method comprising:
attaching a seat cover to a seat cushion of the seat while applying a tension to the seat cover, the seat cushion holding the plurality of sensor cells for detecting a pressure applied to the seat; and
repeating application of a force to the seat cover and release of the seat cover from the force, a plurality of times.

26. The method according to claim 25, wherein pressurized air is blown to the seat cover so that the force is applied to the seat cover.

27. The method according to claim 25, wherein the force is applied to the seat cover by a roller.

28. A method for checking a passenger distinguishment system for distinguishing a passenger on a seat based on outputs from a plurality of sensor cells installed in the seat, the method comprising:
installing the plurality of sensor cells in the seat, the plurality of sensor cells including a judgment cell that is disposed at a specific position in the seat;
applying a pressure to a seat surface of the seat;
comparing an output from the judgment cell with a reference value to decide whether the outputs from the plurality of sensor cells are stable; and
performing a conditioning operation to the seat when the output from the judgment cell is larger than the reference value.

29. The method according to claim 28, wherein the conditioning operation comprises applying a force to the seat and releasing the seat from the force.

30. The method according to claim 28, wherein the passenger is distinguished based on the outputs from the plurality of sensor cells excluding the judgment cell.
